(19) United States
(12) Patent Application Publication
(10) Pub. No.: US 2017/0169390 A1
(43) Pub. Date: Jun. 15, 2017

(54) Method for Providing Anonymous Peer Feedback for Work Teams

(71) Applicant: Jesse Garret Wesselink, Greensboro, NC (US)

(72) Inventor: Jesse Garret Wesselink, Greensboro, NC (US)

(21) Appl. No.: 15/381,099

(22) Filed: Dec. 15, 2016

Related U.S. Application Data
(60) Provisional application No. 62/267,636, filed on Dec. 15, 2015.

(51) Int. Cl. G06Q 10/10; H04L 29/08; H04L 12/58; H04L 29/06

(52) U.S. Cl. CPC G06Q 10/103; H04L 63/0421; H04L 67/22; H04L 51/22

(57) ABSTRACT

A method for providing anonymous feedback to members within a group utilizes a manager account and a plurality of employee accounts that are managed by a remote server. In order to avoid abuse of the anonymous feedback, the method consists of a plurality of predetermined feedback messages that are relevant to the group represented by the manager account and the employee accounts. When a desired message is selected from the predetermined feedback messages, the remote server associates the desired message with a specific employee account. The process is repeated to generate a history of received feedback messages for the specific employee account. The specific employee account is then periodically notified to view the history of received feedback messages. Additionally, the manager account can also view the history of feedback messages of the specific employee account. The identity of the sender of the desired message is concealed to promote team harmony.

The current application claims a priority to the U.S. Provisional Patent application Ser. No. 62/267,636 filed on Dec. 15, 2015.

### FIELD OF THE INVENTION

The present invention relates generally to a network-accessible computer-executable method for empowering employees in an organization to continuously and anonymously hold their peers accountable for their work performance. In particular, the present invention relies on selection of feedback messages by one employee to anonymously send to another employee, storage of those messages in a network accessible server, retrieval of cumulative summaries with tallies of messages and unique senders, and triggering of alerts to a manager when frequencies exceed defined limits.

### BACKGROUND OF THE INVENTION

The management and human resources industries have always been understandably wary of using internal feedback mechanisms that are totally anonymous (meaning the individual source of feedback is not even known to the manager or the organization), due to the potential for abuses from workers who would not be held accountable for how they use such a mechanism. While totally anonymous processes are currently employed in forms of discrete generalized surveys about an organization as a whole, or about abstract ideas or projects, they are never employed for continual, on-demand, direct statements of feedback to individual peers. Such a use does not seem obvious in the industry due to the perception of possible intentional abuses or unintentional abuses. To the contrary, total anonymity for a feedback tool that can be used at any time with unlimited frequency runs counter to the conventional wisdom about personal and peer accountability, which encourages face-to-face conversations for situational accountability. It has never before been conceived how the advantages of totally anonymous and continuous feedback could be employed while eliminating undue risks of abuses or harm. It has also never been conceived that a continuous flow of on-demand anonymous feedback could then be used to alert managers to cumulative patterns of perception from multiple peers that may indicate the need for coaching or other managerial interventions.

The system introduced by the present invention uniquely defines a process whereby truly anonymous feedback can be safely utilized as an individual, direct, continuous peer accountability mechanism to effectively motivate improvements in teamwork and quality.

### BRIEF DESCRIPTION OF THE DRAWINGS

FIG. 1 is a system diagram of the present invention.

FIG. 2 is a flowchart illustrating the basic overall process of the present invention.

FIG. 3 is a flowchart illustrating the basic overall process of receiving an information request.

FIG. 4 is a flowchart illustrating the basic overall process of creating a new feedback message.

FIG. 5 is a flowchart illustrating the basic overall process of editing one of the plurality of predetermined messages.

FIG. 6 is a flowchart illustrating the basic overall process selecting between a positive designation and a negative designation.

FIG. 7 is a flowchart illustrating the basic overall process of tallying a total number of positive messages.

FIG. 8 is a flowchart illustrating the basic overall process of tallying a total number of negative messages.

FIG. 9 is a flowchart illustrating the basic overall process tallying a total number of occurrences for each received feedback message.

FIG. 10 is a flowchart illustrating the basic overall process tallying a total number of origination employees for each received feedback message.

FIG. 11A is a flowchart illustrating the basic overall process calculating a lowest allowable ratio of the total number of positive messages to the total number of negative messages.

FIG. 11B is a continuation of the flowchart illustrating the basic overall process calculating a lowest allowable ratio between the total number of positive messages and the total number of negative messages

FIG. 12 is a flowchart illustrating the basic overall process displaying content according to the notification time interval.

FIG. 13 is a flowchart illustrating the basic overall process sending an excessive negative feedback notification.

FIG. 14 is a flowchart illustrating the basic overall process of displaying the improvement notification.

FIG. 15 is a flowchart illustrating the basic overall process illustrating the use of the administrator account with a plurality of departmental categories.

FIG. 16 is a flowchart illustrating the basic overall process of providing an occupational role for each employee account.

FIG. 17 is a flowchart illustrating the basic overall process of preventing the execution of Step G, if the total number of forwarded message is less than the specified threshold for forwarded messages.

### SUMMARY OF THE INVENTION

The present invention introduces a method to provide anonymous feedback reviews to peers within a group. As an end result, the present invention expects to promote self-improvement while developing team harmony. To do so, a manager account and a plurality of employee accounts are used. The manager account and the plurality of employee accounts uses a structure of inputs, storage in a database structure, and outputs along with specific rules, calculations, and restrictions.

When the present invention is used, an employee uses a unique account ID and password to gain access to the employee input interface which is readily available at any time. The employee can then proceed to provide anonymous feedback to a peer within the group. When providing anonymous feedback to a peer, the employee is prompted to select from a plurality of predetermined feedback messages. The predetermined feedback messages are catered to address the issues that can occur within the department in which the present invention is being used. As an example, if the present invention is being used in healthcare, the predetermined feedback messages will be related to healthcare related issues. The predetermined feedback messages eliminate the possibility of the employee providing abusive feedback to another peer. If a first employee sends an anonymous feedback to a second employee, the present invention saves the anonymous feedback in a history of received feedback messages for the second employee. In particular, the history of received feedback messages will be a log for all the anonymous feedback received by the second employee. Both the manager and the second employee can view the received feedback. However, the feedback would not be available for viewing as soon as the feedback is received. As an example, the feedback received within a given week would be available for viewing the following week. This eliminates the possibility of the receiver being able to guess the origin of the feedback. The present invention allows to filter the history of received feedback messages. As an example, if the second employee who received the anonymous feedback submits an information request to view the feedback within the last month, the present invention displays the saved data that is related to the information request.

As mentioned earlier, the predetermined feedback messages can vary per use. The present invention enables the manager to add, modify or delete any of the predetermined feedback messages. When new needs arise, the manager determines the needed changes and adds, modifies or deletes one or more of the predetermined feedback messages.

Through the anonymous feedback system, the present invention intends to provide not only constructive criticism but also encouragement for self-improvement. In order to do so, each of the predetermined feedback messages are associated with a positive designation or a negative designation. The predetermined feedback messages with a positive designation are intended for encouragement. On the other hand, the predetermined feedback message with a negative designation is intended for constructive criticism. The positive designation or the negative designation is assigned by the manager account.

The positive designation and the negative designation is used to understand the behavioral patterns and related information of each employee. In doing so, the present invention tallies a total number of positive messages and a total number of negative messages for each employee. In a much more detailed perspective, the present invention also tallies the total number of occurrences for each received feedback message. As an example, if an employee received a feedback with a negative designation, the total number of negative designation is updated. Moreover, the total for the specific feedback is also updated.

As seen on many occasions, anonymous feedback systems can be abused to exaggerate individual perceptions. In particular, an individual can repeatedly send the same message so that it appears as if their perception is shared by multiple individuals. The present invention addresses the issue by tallying a total number of origination employees for each received feedback message. As an example, we will consider that a specific employee received the feedback “Less breaks. More patient care is required”. If the feedback was received multiple times through a single source, we see that the feedback is an individual perception. On the other hand, if the feedback was received multiple times from multiple sources, we understand that the issue is a common perception.

The present invention is intended to encourage self-improvement and not discourage an individual. If the calculated total number of negative messages is considerably larger than the total number of positive messages the employee can be discouraged. In order to avoid such situations, the present invention is provided with a lowest allowable ratio between positive messages and negative messages. The intention of the lowest allowable ratio is to prompt an employee providing feedback to consider submitting a feedback with a positive designation if the intended receiver has a high number of feedbacks with the negative designation.

As discussed earlier, the present invention is intended to promote self-improvement. To recognize any notable improvements of an employee, the present invention is equipped with the ability of revoking a previously submitted feedback. As an example, we will consider an instance in which the first employee submitted a feedback to the second employee stating that “less breaks. More patient care is required”. If the second employee improved in the area of concern, the first employee can revoke the previously submitted feedback so that the improvement of the second employee is aptly recognized.

Even though the present invention is intended to provide constructive criticism, the present invention is also designed to address any habitual behavior of an employee that can harm the development of the team. In order to do so, the present invention is provided with a multiple-sender threshold. The multiple-sender threshold is used to compare with an actual multiple-sender frequency for a desired message. The actual multiple-sender frequency is calculated by searching through the remote server and identifying the number of times the desired message was received within a given time. If the actual multiple-sender frequency is greater than the occurrence threshold, it is implied that the matter addressed by the desired message needs to be focused on. In such cases, the present invention sends an excessive negative feedback notification to the manager so that the manager can look into the issue addressed by the desired message.

Although the present invention is only described for using with one manager and a plurality of employees under the manager, the present invention can be used in a larger organizational context too. More specifically, the present invention can be used for sending feedback messages from employees in one department to employees in a plurality of other departments. In such instances, the present invention is provided with an administrator account which then designates the manger for each of the departments. Moreover, the administrator can access each departmental category as the manager. Additionally, the administrator account has the ability to adjust global settings for the manager and the employees of each department.

In order to address different job roles, the present invention consists of multiple restricted sets of messages that appear as subsets of the predetermined feedback messages. Each restricted set of messages is designed to address role specific duties for a particular role.

For a peer feedback system to be effective, members of a group must participate in the process by sending feedback regarding fellow peers. To encourage participation, the present invention requires all employees to exceed a certain threshold of sent messages prior to viewing the feedback received from other members in the group. In other words, if the first employee wishes to view his or her perception among the group, the first employee first needs to have provided feedback to other members of the group.

### DETAIL DESCRIPTIONS OF THE INVENTION

All illustrations of the drawings are for the purpose of describing selected versions of the present invention and are not intended to limit the scope of the present invention.

The present invention introduces a method in which an employee can provide anonymous feedback to a peer. By utilizing the present invention, peer accountability is improved without necessarily disrupting team harmony. The present invention gives each team member a platform to express his or her perceptions about other members of the team so that workplace confrontation can be avoided in instances where it is not necessary. As a result of using the present invention, each member of a team can learn how he or she is perceived by his or her team members, take steps to improve the perceptions, and measure the changes in perceptions that result. Through this ongoing process, members of a team engage in self-improvement as well as contribute towards the improvement of their peers.

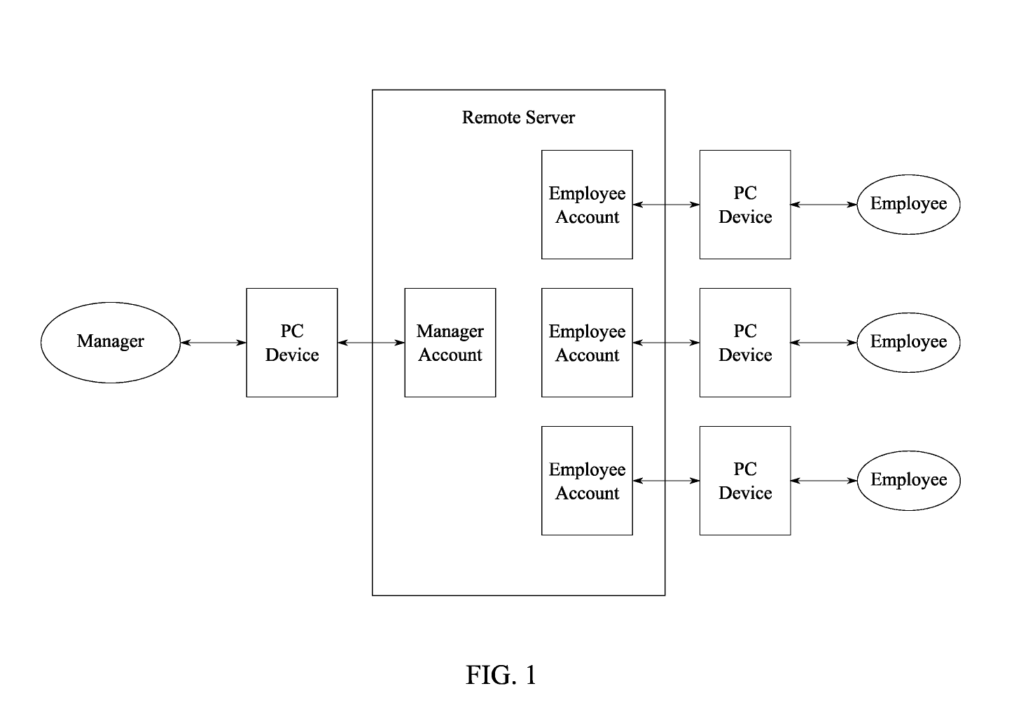

As described earlier, the present invention is intended to be used within a group of peers. As illustrated in FIG. 1, the present invention provides a manager account and a plurality of employee accounts, all of which are managed by at least one remote server (Step A). Moreover, the manager account and each of the plurality of employee accounts are associated with a corresponding personal computing (PC) device that is used to carry out the functionalities of the present invention during each use. The corresponding PC device can be, but is not limited to, a smart-phone, a desktop, a laptop, or another comparable computing device. The manager account has administrative functionalities on the present invention over the plurality of employee accounts. Preferably, the leader of a given group would control the manager account and all other members of the group would control each of the plurality of employee accounts.

One safeguard to prevent abuses of anonymous feedback is the requirement to choose from a selection of predetermined messages. To do so, the present invention is provided with a plurality of predetermined feedback messages that is stored on the remote server (Step B). In particular, the present invention purposefully excludes any prompts for the user to provide feedback as free text. The predetermined feedback messages vary in different embodiments of the present invention. As an example, the content in the predetermined feedback messages can vary from one department or business to another since the duties of one department or business can be different from the duties of another department or business. Preferably, the plurality of predetermined feedback messages is generated and customized through the manager account, using suggestions and input that is received from the employees in the team. The categories addressed by the plurality of predetermined feedback messages can be, but are not limited to, communication, accountability, empowerment, or respect. Each of the categories will associate a distinct subset from the plurality of predetermined feedback messages to provide for easier selection of messages by the plurality of employee accounts, and for reporting and tracking of cumulative feedback patterns or trends at a category level. The plurality of predetermined feedback messages is generated and modified by the manager account to accommodate team needs, known behavioral patterns, and organizational values.

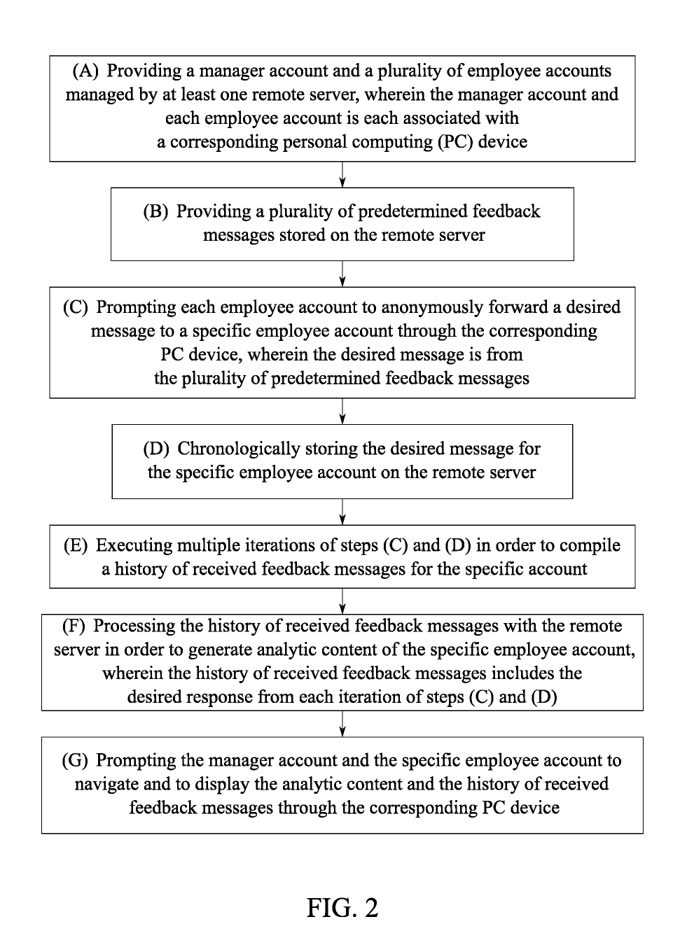

When the present invention is being used by multiple employees to provide feedback regarding a peer, the present invention initially prompts each employee account to anonymously forward a desired message to a specific employee account through the corresponding PC device (Step C). The desired message is selected from the plurality of predetermined feedback messages through the corresponding PC device. When the desired message is forwarded, the present invention chronologically stores the desired message for the specific employee account on the remote server (Step D). However, most importantly, the present invention does not disclose the identity of the employee account that sent the desired message. The anonymity associated with the process encourages each employee to provide feedback regarding a peer without the concern of any potential confrontations. Step C and Step D is executed in multiple iterations over time to compile a history of received feedback messages for the specific employee account (Step E). At any time, the history of received feedback messages are processed with the remote server to generate analytic content of the specific employee account (Step F). More specifically, the history of received feedback messages includes the desired message from each iteration executed previously. To address the desired messages from each of the iterations, the present invention then prompts the manager account and the specific employee account to navigate and to display the analytic content and the history of received feedback messages through the corresponding PC device (Step G). Therefore, the manager can determine the issues that need to be addressed with each employee/team member on behalf of the group if the employee fails to self-improve. The basic overall process of the present invention is illustrated in FIG. 2.

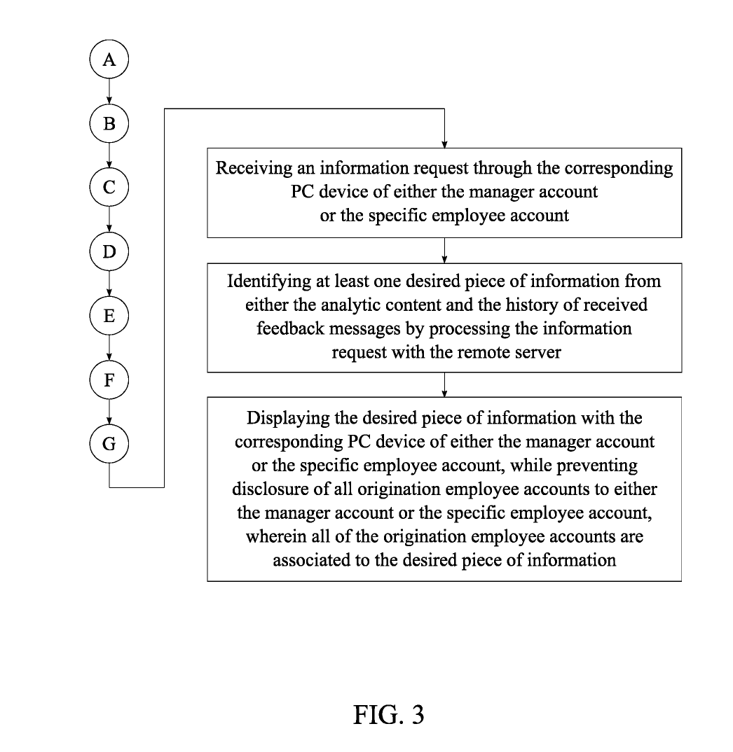

As illustrated in FIG. 3, in order to view information stored on the remote server, the present invention receives an information request through the corresponding PC device of either the manager account or the specific employee account. By processing the information request, the present invention identifies at least one desired piece of information from either the analytic content or the history of received feedback messages. In the preferred embodiment of the present invention, the desired piece of information is a weekly report of the feedback received by the specific employee account. The present invention displays the desired piece of information with the corresponding PC device of either the manager account or the specific employee account. In doing so, the present invention prevents disclosure of all origination employee accounts to either the manager account or the specific employee account, wherein all of the origination employee accounts are associated to the desired piece of information. As an example, if the present invention receives the information request from the manager account, the at least one desired piece of information is displayed from the analytic content or the history of received feedback messages. However, the origination employee account associated with the desired piece of information is not displayed to the manager account. Thus, anonymity of the origination employee account is protected.

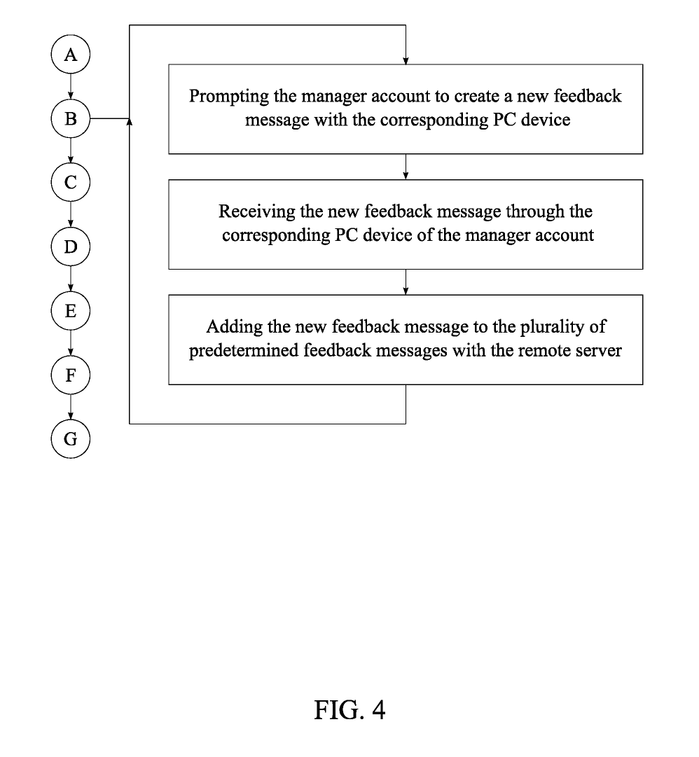

As mentioned earlier, the plurality of predetermined feedback messages is generated through the manager account. With developments within a given group, there can be a need to update the plurality of predetermined feedback messages. As shown in FIG. 4, if the need to add new feedback messages occurs with time, the present invention prompts the manager account to create a new feedback message with the corresponding PC device. If the manager account adds a new feedback message, the present invention receives the new feedback message through the corresponding PC device of the manager account. When received, the present invention adds the new feedback message to the plurality of predetermined feedback messages with the remote server. The new feedback message will now be displayed as part of the plurality of predetermined feedback messages so that the new feedback message can also be selected as the desired message.

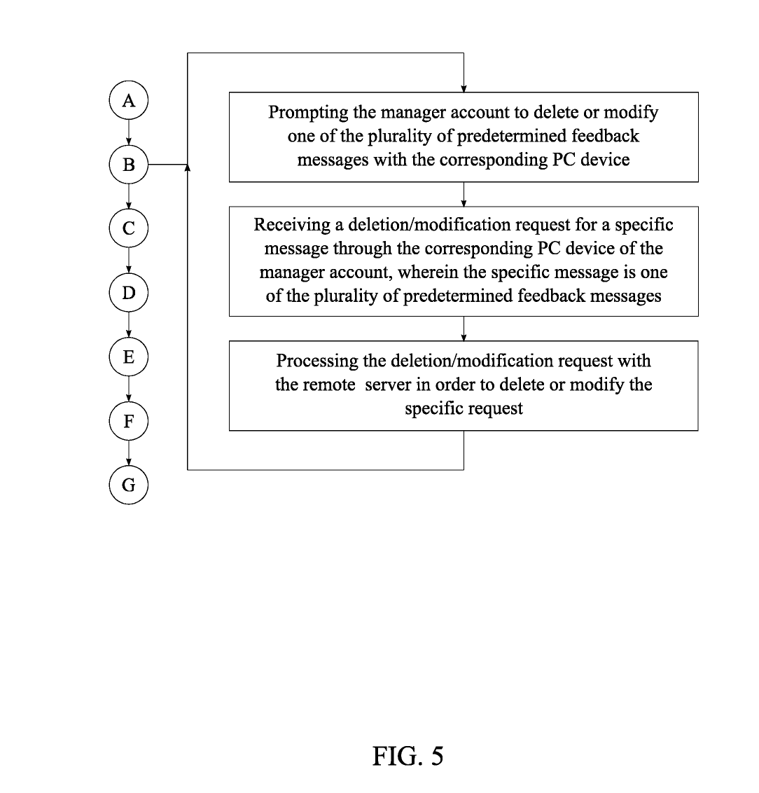

The manager account also has the ability to edit the plurality of predetermined feedback messages. If the need to edit one of the plurality of predetermined feedback messages occurs, the present invention prompts the manager account to delete or modify one of the plurality of predetermined feedback messages with the corresponding PC device. As illustrated in FIG. 5, the present invention receives a deletion/modification request for a specific message from the plurality of predetermined feedback messages. In particular, the deletion/modification request is received through the corresponding PC device of the manager account. The present invention then proceeds to process the deletion/modification request with the remote server in order to delete or modify the specific message. The ability to delete or modify is important to ensure that the plurality of predetermined messages accurately address the issues or needs within the team.

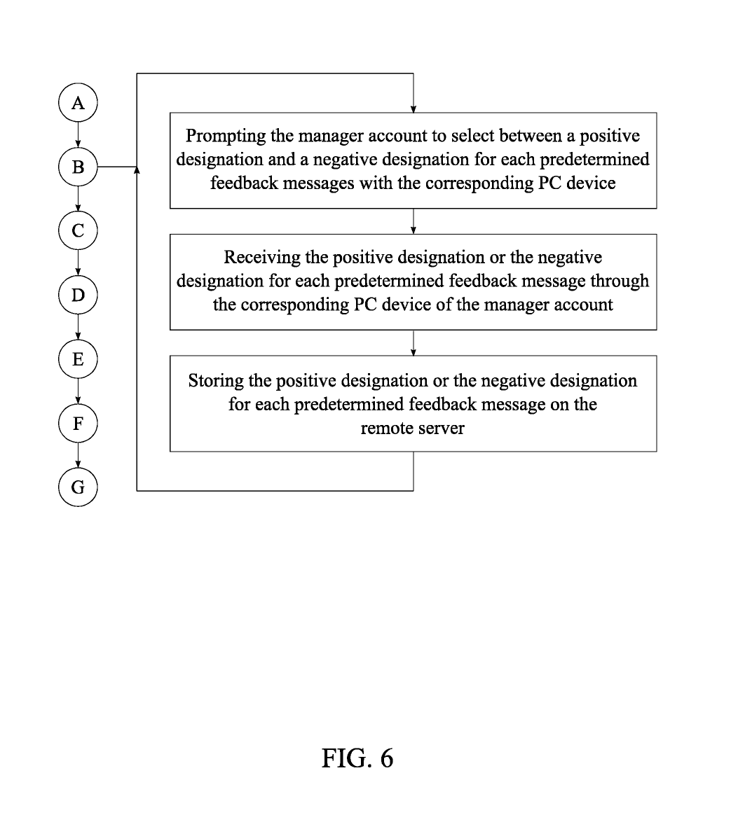

The plurality of predetermined feedback messages is used to provide encouragement and/or constructive criticism to each of the members working within a group. To provide encouragement, the plurality of predetermined feedback messages consists of a set of positive messages. On the other hand, the plurality of predetermined messages also consists a set of negative messages to provide constructive criticism. The binary objective for each of the plurality of predetermined feedback messages is determined by the manager account. As shown in FIG. 6, the present invention prompts the manager account to select between a positive designation and a negative designation for each of the predetermined feedback messages with the corresponding PC device. When the manager account determines between the positive designation and the negative designation, the present invention receives the positive designation or the negative designation for each predetermined feedback message through the corresponding PC device of the manager account. Next, the present invention stores the positive designation or the negative designation for each predetermined feedback message on the remote server. Therefore, when the desired message is selected, the desired message is stored for the specific employee account along with the positive designation or the negative designation.

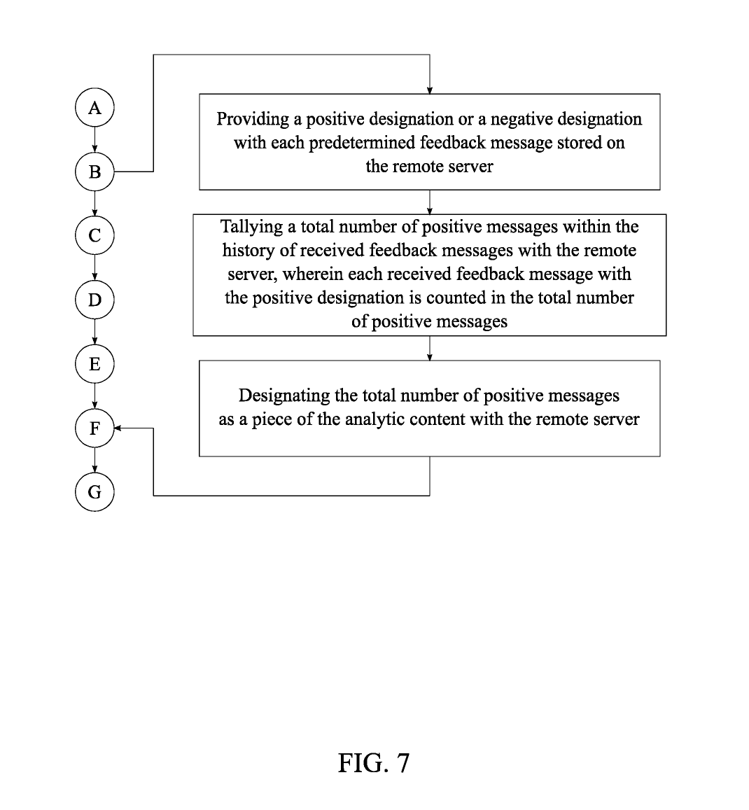

In order to quantify peer perceptions of each member of the group, the present invention tallies a total number of positive messages within the history of received feedback messages with the remote server. More specifically, each received feedback message with the positive designation is counted in the total number of positive messages. As shown in FIG. 7, the present invention designates the total number of positive messages for the specific employee account as a piece of the analytic content with the remote server. The total number of positive messages helps the specific employee account to identify personal strengths. The number of positive messages portrays the strengths of the specific employee account to the manager account.

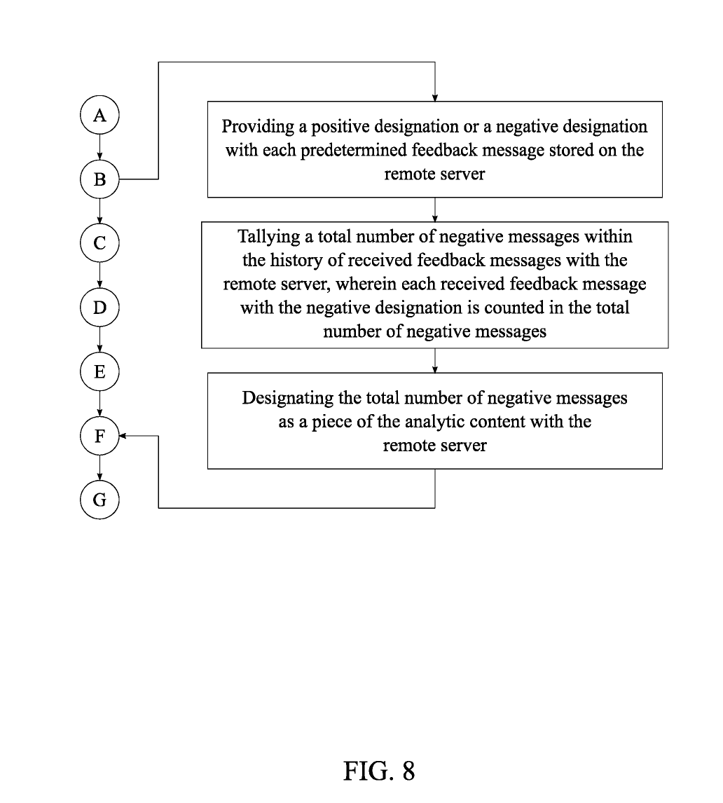

As shown in FIG. 8, the present invention tallies a total number of negative messages within the history of received feedback messages with the remote server. In doing so, each received feedback message with the negative designation is counted in the total number of negative messages. The present invention designates the total number of negative messages for the specific employee account as a piece of the analytic content with the remote server. The total number of negative messages helps the specific employee account to identify areas of weakness. On the other hand, the total number of negative messages portrays the weaknesses of the specific employee account to the manager account.

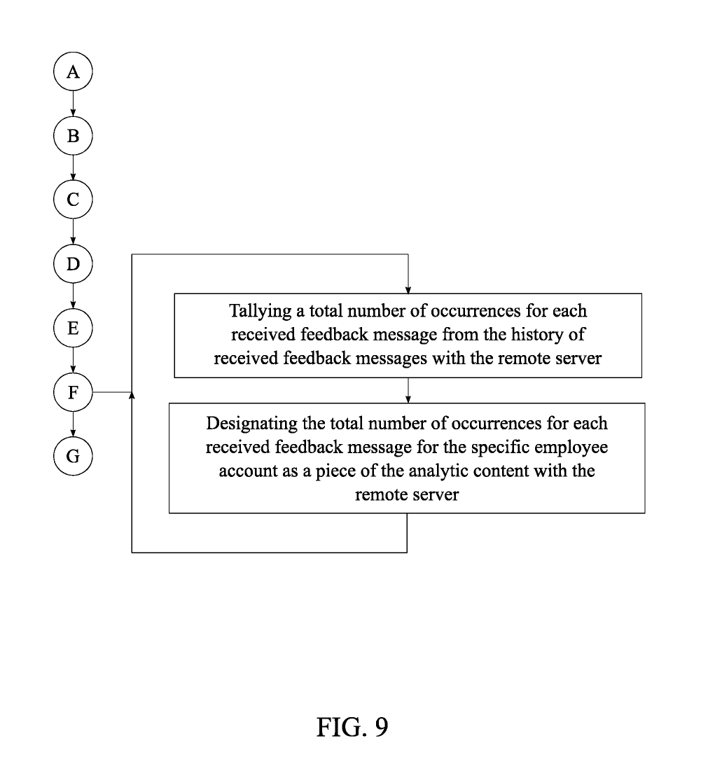

As illustrated in FIG. 9, the present invention tallies a total number of occurrences for each received feedback message from the history of received feedback messages with the remote server. In other words, the total number of occurrences gives the number of iterations the desired message was sent to the specific employee account. The total number of occurrences for each received feedback message for the specific employee account is then designated as a piece of the analytic content with the remote server. This helps the specific employee account and the manager account identify areas that need to be addressed.

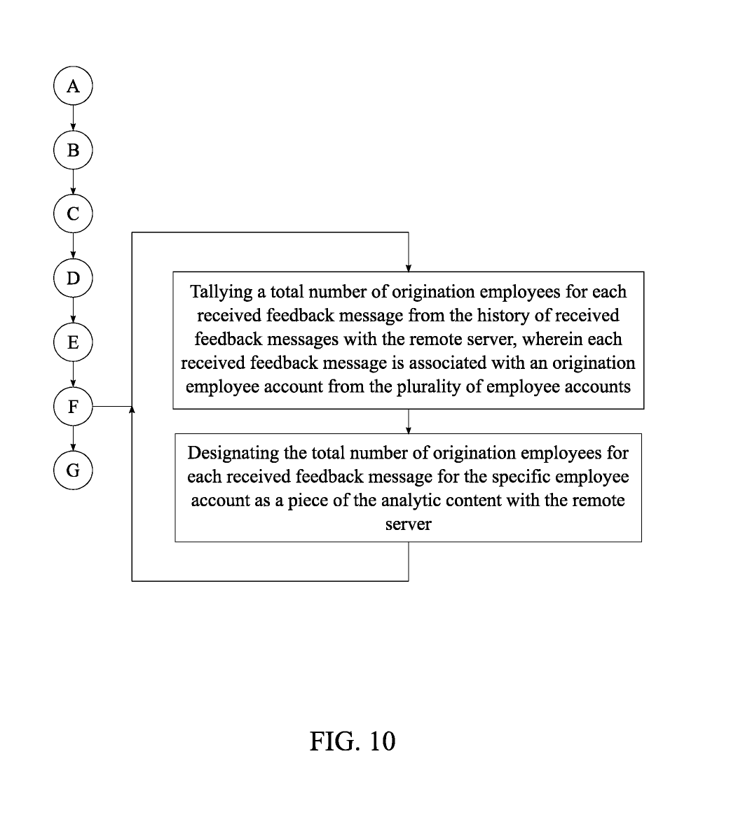

The ability to distinguish between individual perceptions and perceptions that are confirmed by multiple peers is another key aspect of the present invention. As shown in FIG. 10, the present invention tallies a total number of origination employees for each received feedback message from the history of received feedback messages with the remote server. Therefore, each received feedback message is associated with an origination employee account from the plurality of employee accounts. The present invention designates the total number of origination employees for each received feedback message, for the specific employee account, as a piece of the analytic content with the remote server. Therefore, the specific employee account and the manager account can identify if the desired message is an individual perception or a perception shared by multiple members. Thus, a potential abuse of anonymous feedback systems is eliminated. As an example, if the total number of occurrences for the received feedback message is five, and the total number of origination employees is one, the manager account and the specific employee account can identify the received feedback message to be an individual perception. On the other hand, if the total number of occurrences is five and the total number of origination employees is five, the received feedback message can be identified as a shared perception among peers.

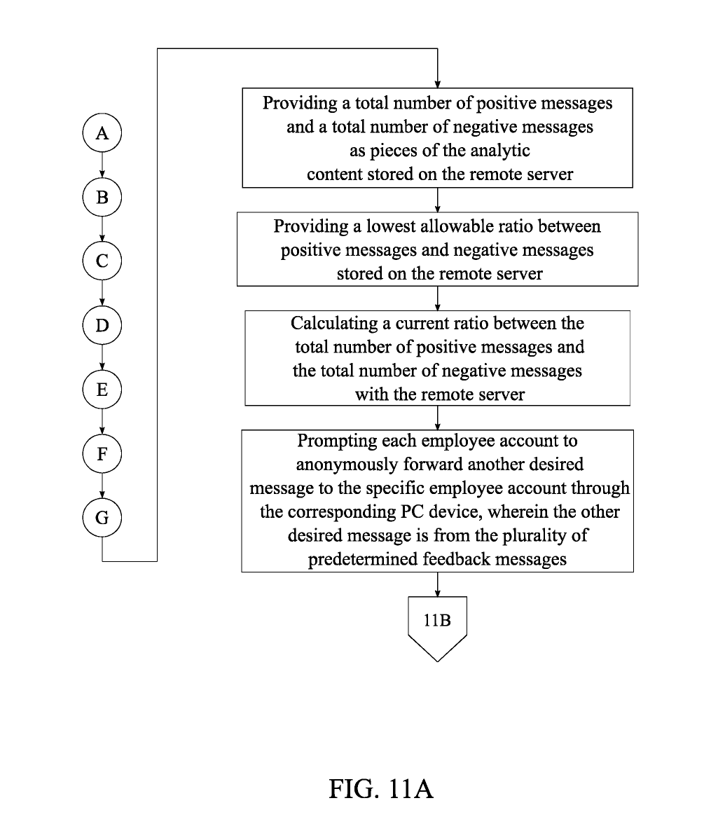

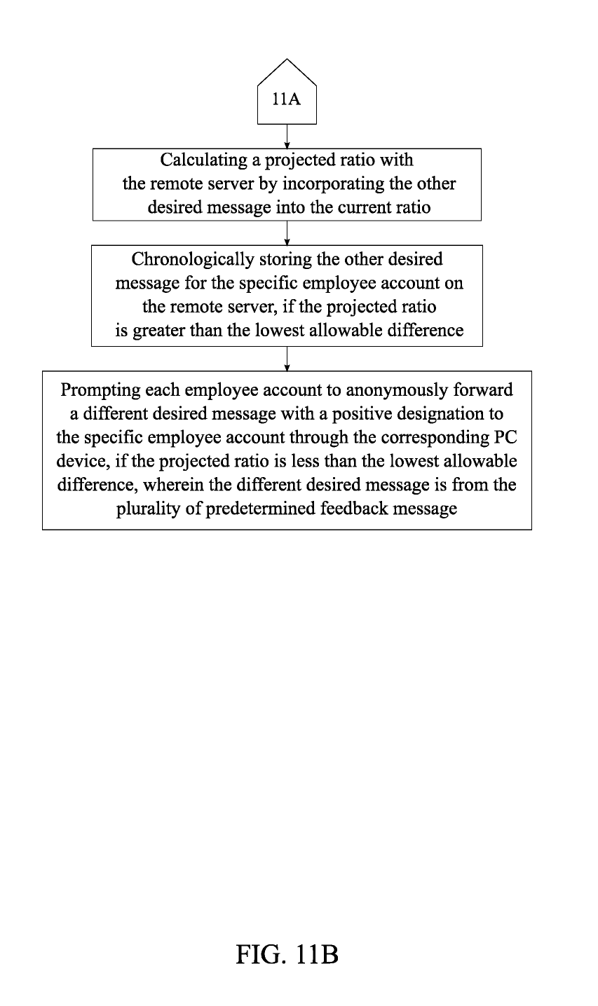

Related to positive and negative messages, the present invention includes a second safeguard to prevent abuses of anonymous feedback. As shown in FIG. 11A and FIG. 11B, the present invention provides a lowest allowable ratio between positive messages and negative messages stored on the remote server for the plurality of employee accounts. The lowest allowable ratio prevents an individual from becoming discouraged by receiving a higher number of feedback messages with the negative designation compared to the number of feedback messages with a positive designation. To enforce the lowest allowable ratio, the present invention calculates a current ratio between the total number of positive messages and the total number of negative messages received by each of the plurality of employee accounts with the remote server. The current ratio is an indicator of the total number of positive messages and the total number of negative messages for the specific employee account at that given instant. To maintain the lowest allowable ratio, the present invention prompts each employee account to anonymously forward another desired message to the specific employee account through the corresponding PC device wherein the other desired message is from the plurality of predetermined feedback messages. Upon receiving the other desired message, the present invention calculates a projected ratio with the remote server by incorporating the other desired message into the current ratio. If the projected ratio is greater than the lowest allowable ratio, the present invention chronologically stores the other desired message for the specific employee account on the remote server. However, if the projected ratio is less than the lowest allowable ratio, the present invention prompts each employee account to anonymously forward a different desired message with a positive designation to the specific employee account. Similar to the other desired message, the different desired message is also selected from the plurality of predetermined feedback messages.

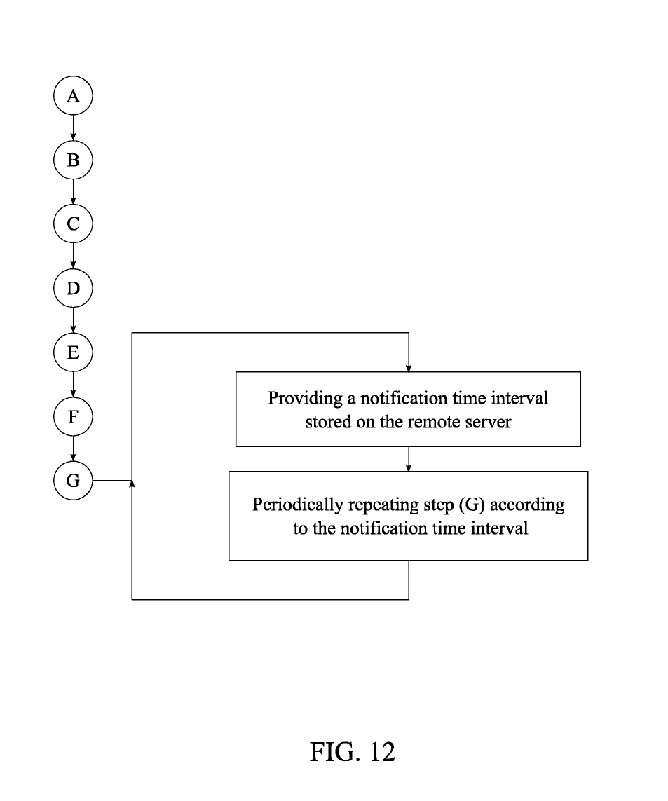

Anonymity is a major aspect of the present invention. As seen in FIG. 12, to avoid revealing feedback information to the specific employee account, the present invention is provided with a notification time interval that is stored on the secure server. The notification time interval prevents the present invention from continuously displaying the history of received feedback messages. For instance, in the preferred embodiment of the present invention, the history for feedback messages is displayed on a weekly basis so that the total number of positive messages and the total number of negative messages are displayed weekly, and not by day or hour. This prevents the specific employee account, who received the desired message, from successfully guessing the source from which the desired message was initiated. When the history of feedback messages is displayed according to the notification time interval, the present invention periodically executes Step G to prompt the manager account and the specific employee account to navigate and to display the analytic content and the history of received feedback messages through the corresponding PC device.

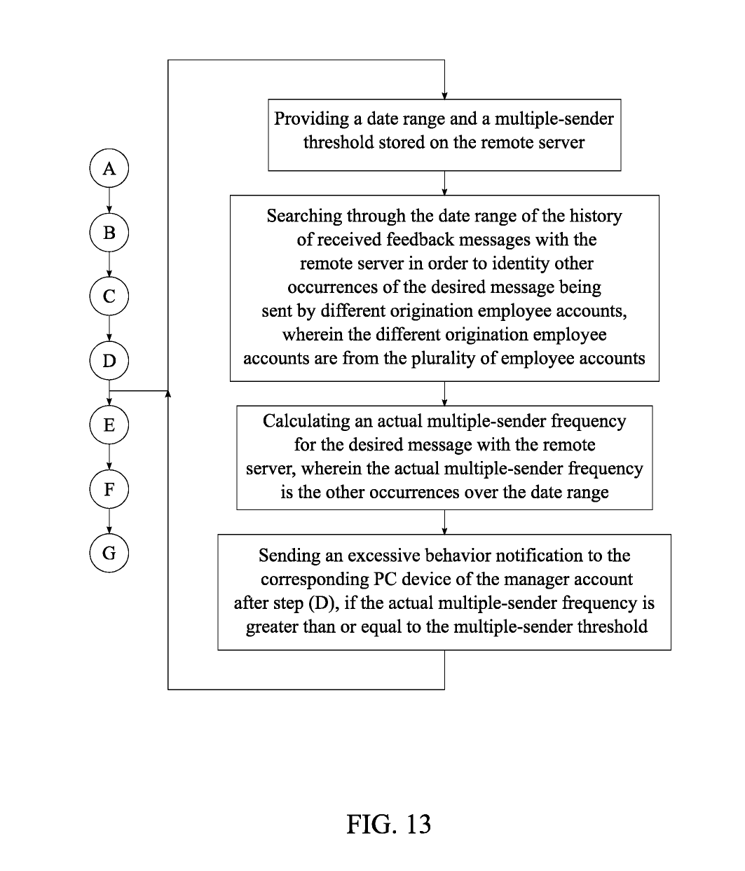

As discussed earlier, the present invention allows the manager account to determine the issues that need to be addressed within the group. In order to aid with the process, the present invention provides a date range and a multiple-sender threshold stored on the remote server as shown in FIG. 13. The present invention searches through the date range of the history of received feedback messages with the remote server in order to identify other occurrences of the desired message being sent by different origination employee accounts. The search is used to calculate an actual multiple-sender frequency for the desired message with the remote server. The actual multiple-sender frequency is the other occurrences over the date range. If the actual multiple-sender frequency is greater than or equal to the multiple-sender threshold, the present invention sends an excessive negative feedback notification to the corresponding PC device of the manager account after Step D. As an example, the excessive negative feedback notification can indicate that a team member left messes that needed to be cleaned up on multiple occasions within a given time period and it was confirmed my multiple members of the team.

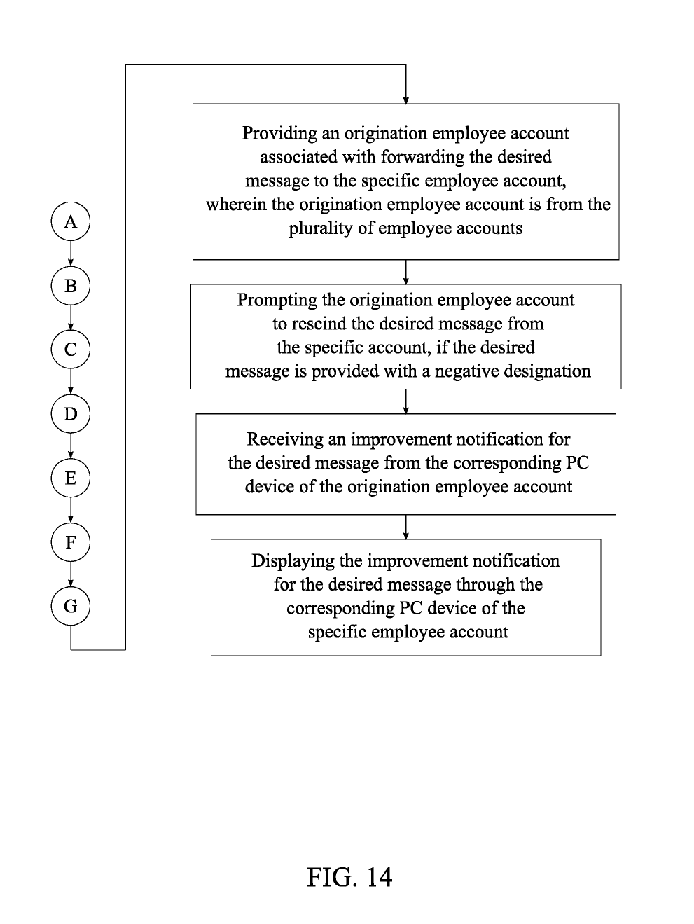

The ultimate objective of the present invention is to promote self-improvement of members within a group. As a part of this process, the present invention allows the specific employee account to be recognized for notable self-improvements by rescinding a negative feedback left by a peer. As shown in FIG. 14, the present invention is provided with an origination employee account associated with forwarding the desired message to the specific employee account. The origination employee account is from the plurality of employee accounts, and the desired message is provided with the negative designation. If the specific employee account has shown notable self-improvement over time, the present invention prompts the origination employee account to rescind the desired message, which is associated with the negative designation. When revoked, the present invention receives an improvement notification for the desired message from the corresponding PC device of the origination employee account. The present invention displays the improvement notification for the desired message through the corresponding PC device of the specific employee account. This allows the specific employee account to identify areas of improvement.

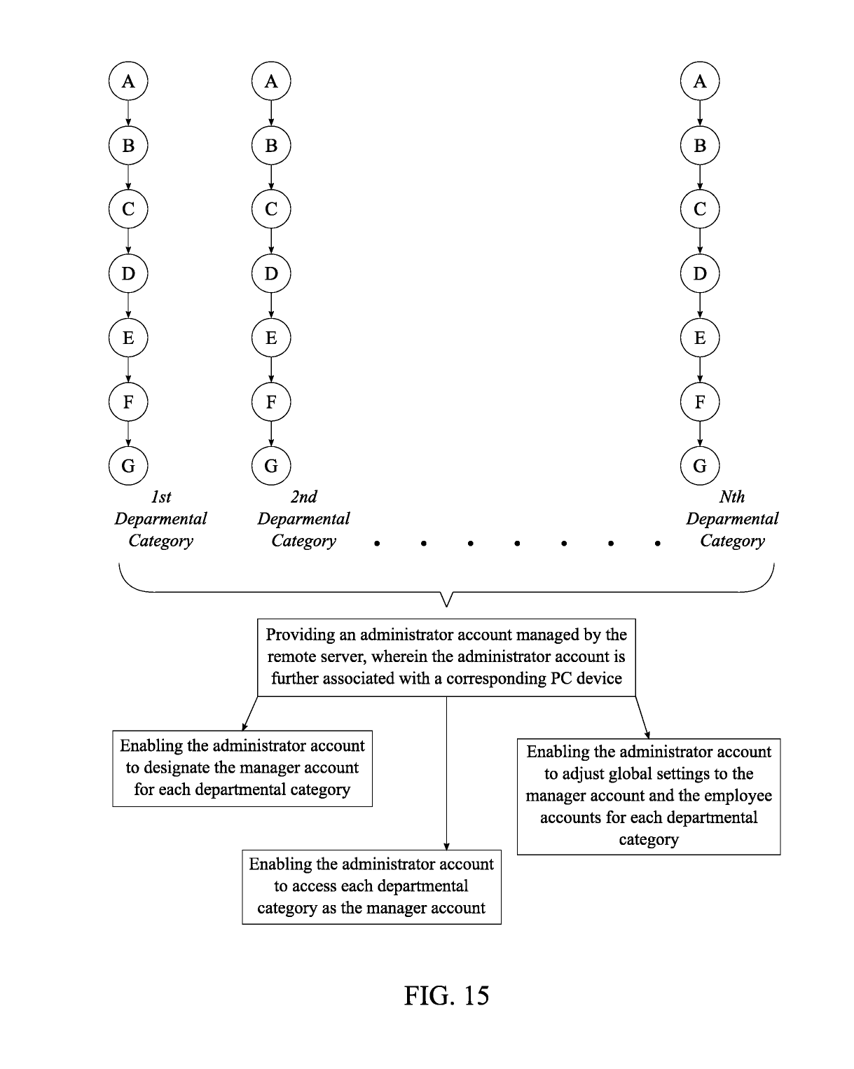

For the present invention to be used on a larger scale, the present invention is provided with a plurality of departmental categories that is managed through the remote server. When the plurality of departmental categories is provided, the present invention executes an iteration of Step A through Step G for each departmental category. As seen in FIG. 15, in order to manage the plurality of departmental categories, the present invention is provided with an administrator account that is managed by the remote server and is associated with a corresponding PC device. The present invention enables the administrator account to designate the manager account for each departmental category between the corresponding PC device and the remote server. Moreover, the administrator account can access each departmental category as the manager account between the corresponding PC device and the remote server. The present invention further enables the administrator account to adjust global settings to the manager account and the plurality of employee accounts for each departmental category between the corresponding PC device and the remote server.

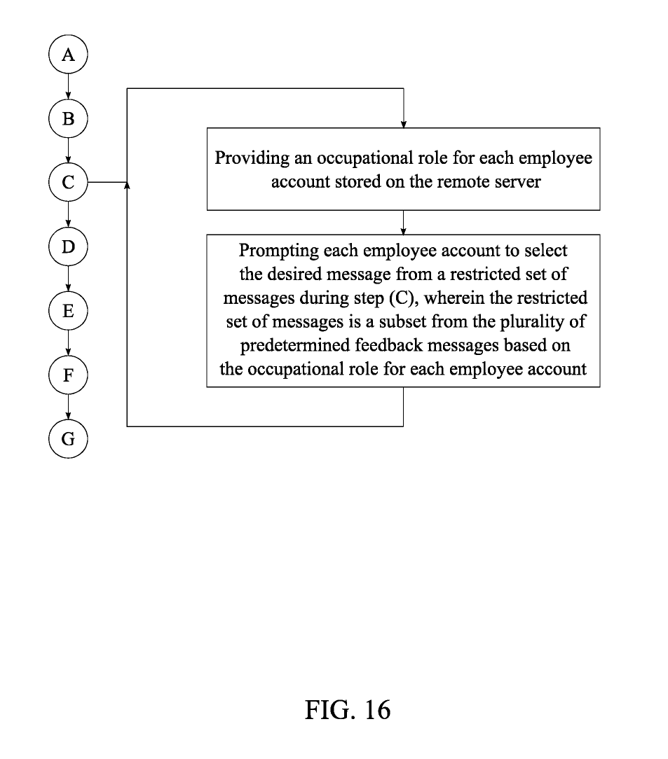

The roles of a team member within a group can vary. Therefore, the plurality of predetermined feedback messages may not cover all aspects of a given role. In order to address the issue, the present invention provides an occupational role for each employee account stored on the remote server as shown in FIG. 16. The occupational role for the plurality of employee accounts can vary in different embodiments of the present invention. When the occupational role is provided, the present invention prompts each employee account to select the desired message from a restricted set of messages during Step C. In particular, the restricted set of messages is a subset from the plurality of predetermine feedback messages based on the occupational role for each employee account.

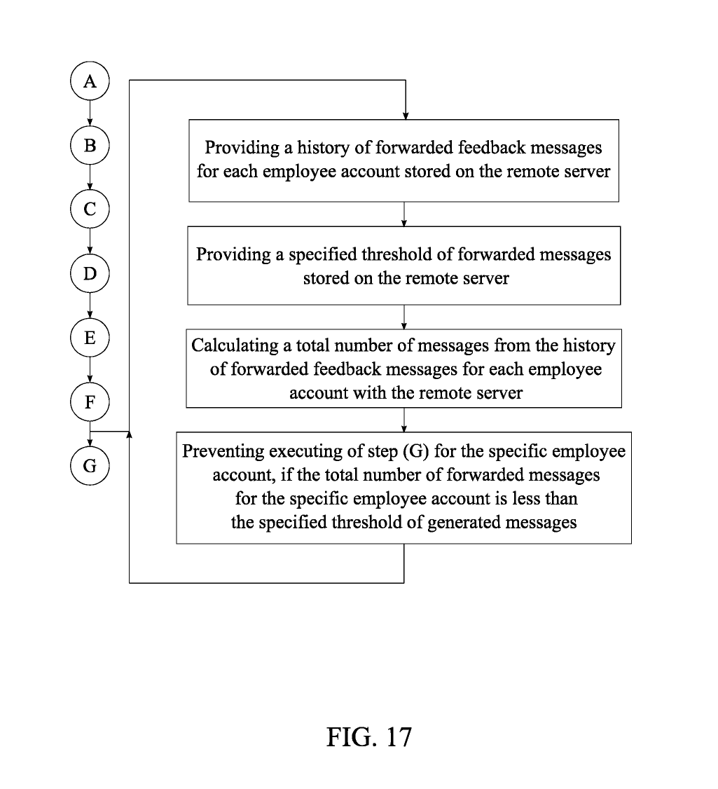

As discussed earlier, an objective of the present invention is to promote involvement of all members of a group. As illustrated in FIG. 17, the present invention provides a history of forwarded feedback messages for each of the plurality of employee accounts on the remote server. Each received feedback message is associated with the origination employee account, and the history of generated feedback messages is created by chronologically storing the desired messages from the origination employee account. The present invention provides a specified threshold of forwarded messages stored on the remote server which needs to be exceeded in order to view the feedback given by other peers. The present invention calculates a total number of messages from the history of forwarded feedback messages for each employee account with the remote server. The calculation is used to prevent the execution of Step G for the specific employee account, if the total number of forwarded messages for the specific employee account is less than the specified threshold of forwarded messages.

Although the invention has been explained in relation to its preferred embodiment, it is to be understood that many other possible modifications and variations can be made without departing from the spirit and scope of the invention as hereinafter claimed.

What is claimed is:

1. A method for providing anonymous peer feedback for work teams, the method comprises the steps of:
(A) providing a manager account and a plurality of employee accounts managed by at least one remote server, wherein the manager account and each employee account is each associated with a corresponding personal computing (PC) device;
(B) providing a plurality of predetermined feedback messages stored on the remote server;
(C) prompting each employee account to anonymously forward a desired message to a specific employee account through the corresponding PC device, wherein the desired message is from the plurality of predetermined feedback messages;
(D) chronologically storing the desired message for the specific employee account on the remote server;
(E) executing multiple iterations of steps (C) and (D) in order to compile a history of received feedback messages for the specific employee account;
(F) processing the history of received feedback messages with the remote server in order to generate analytic content of the specific employee account, wherein the history of received feedback messages includes the desired message from each iteration of steps (C) and (D); and
(G) prompting the manager account and the specific employee account to navigate and to display the analytic content and the history of received feedback messages through the corresponding PC device.

2. The method for providing anonymous peer feedback for work teams as claimed in claim 1 further comprises the steps of:
receiving an information request through the corresponding PC device of either the manager account or the specific employee account;
identifying at least one desired piece of information from either the analytic content and the history of received feedback messages by processing the information request with the remote server; and
displaying the desired piece of information with the corresponding PC device of either the manager account or the specific employee account, while preventing disclosure of all origination employee accounts to either the manager account or the specific employee account, wherein all of the origination employee accounts are associated to the desired piece of information.

3. The method for providing anonymous peer feedback for work teams as claimed in claim 1 further comprises the steps of:
prompting the manager account to create a new feedback message with the corresponding PC device;
receiving the new feedback message through the corresponding PC device of the manager account; and
adding the new feedback message to the plurality of predetermined feedback messages with the remote server.

4. The method for providing anonymous peer feedback for work teams as claimed in claim 1 further comprises the steps of:
prompting the manager account to delete or modify one of the plurality of predetermined feedback messages with the corresponding PC device;
receiving a deletion/modification request for a specific message through the corresponding PC device of the manager account, wherein the specific message is one of the plurality of predetermined feedback messages; and
processing the deletion/modification request with the remote server in order to delete or modify the specific request.

5. The method for providing anonymous peer feedback for work teams as claimed in claim 1 further comprises the steps of:
prompting the manager account to select between a positive designation and a negative designation for each predetermined feedback messages with the corresponding PC device;
receiving the positive designation or the negative designation for each predetermined feedback message through the corresponding PC device of the manager account; and
storing the positive designation or the negative designation for each predetermined feedback message on the remote server.

6. The method for providing anonymous peer feedback for work teams as claimed in claim 1 further comprises the steps of:
providing a positive designation or a negative designation with each predetermined feedback message stored on the remote server;
tallying a total number of positive messages within the history of received feedback messages with the remote server, wherein each received feedback message with the positive designation is counted in the total number of positive messages; and
designating the total number of positive messages for the specific employee account as a piece of the analytic content with the remote server.

7. The method for providing anonymous peer feedback for work teams as claimed in claim 1 further comprises the steps of:
providing a positive designation or a negative designation with each predetermined feedback message stored on the remote server;
tallying a total number of negative messages within the history of received feedback messages with the remote server, wherein each received feedback message with the negative designation is counted in the total number of negative messages; and
designating the total number of negative messages for the specific employee account as a piece of the analytic content with the remote server.

8. The method for providing anonymous peer feedback for work teams as claimed in claim 1 further comprises the steps of:
tallying a total number of occurrences for each received feedback message from the history of received feedback messages with the remote server; and
designating the total number of occurrences for each received feedback message for the specific employee account as a piece of the analytic content with the remote server.

9. The method for providing anonymous peer feedback for work teams as claimed in claim 1 further comprises the steps of:
tallying a total number of origination employees for each received feedback message from the history of received feedback messages with the remote server, wherein each received feedback message is associated with an origination employee account from the plurality of employee accounts; and
designating the total number of origination employees for each received feedback message for the specific employee account as a piece of the analytic content with the remote server.

10. The method for providing anonymous peer feedback for work teams as claimed in claim 1 further comprises the steps of:
providing a total number of positive messages and a total number of negative messages as pieces of the analytic content stored on the remote server;
providing a lowest allowable ratio between positive messages and negative messages stored on the remote server;
calculating a current ratio between the total number of positive messages and the total number of negative messages with the remote server;
prompting each employee account to anonymously forward another desired message to the specific employee account through the corresponding PC device, wherein the other desired message is from the plurality of predetermined feedback messages;
calculating a projected ratio with the remote server by incorporating the other desired message into the current ratio;
chronologically storing the other desired message for the specific employee account on the remote server, if the projected ratio is greater than the lowest allowable difference; and
prompting each employee account to anonymously forward a different desired message with a positive designation to the specific employee account through the corresponding PC device, if the projected ratio is less than the lowest allowable difference, wherein the different desired message is from the plurality of predetermined feedback messages.

11. The method for providing anonymous peer feedback for work teams as claimed in claim 1 further comprises the steps of:
providing a notification time interval stored on the remote server; and
periodically repeating step (G) according to the notification time interval.

12. The method for providing anonymous peer feedback for work teams as claimed in claim 1 further comprises the steps of:
providing a date range and a multiple-sender threshold stored on the remote server;
searching through the date range of the history of received feedback messages with the remote server in order to identity other occurrences of the desired message being sent by different origination employee accounts, wherein the different origination employee accounts are from the plurality of employee accounts;
calculating an actual multiple-sender frequency for the desired message with the remote server, wherein the actual multiple-sender frequency is the other occurrences over the date range; and
sending an excessive negative feedback notification to the corresponding PC device of the manager account after step (D), if the actual multiple-sender frequency is greater than or equal to the multiple-sender threshold.

13. The method for providing anonymous peer feedback for work teams as claimed in claim 1 further comprises the steps of:
providing an origination employee account associated with forwarding the desired message to the specific employee account, wherein the origination employee account is from the plurality of employee accounts;
prompting the origination employee account to rescind the desired message from the specific account, if the desired message is provided with a negative designation;
receiving an improvement notification for the desired message from the corresponding PC device of the origination employee account; and
displaying the improvement notification for the desired message through the corresponding PC device of the specific employee account.

14. The method for providing anonymous peer feedback for work teams as claimed in claim 1 further comprises the steps of:
providing a plurality of departmental categories managed by the remote server; and
executing an iteration of steps (A) through (G) for each departmental category.

15. The method for providing anonymous peer feedback for work teams as claimed in claim 14 further comprises the steps of:
providing an administrator account managed by the remote server, wherein the administrator account is further associated with a corresponding PC device; and
enabling the administrator account to designate the manager account for each departmental category between the corresponding PC device and the remote server.

16. The method for providing anonymous peer feedback for work teams as claimed in claim 14 further comprises the steps of:
providing an administrator account managed by the remote server, wherein the administrator account is further associated with a corresponding PC device; and
enabling the administrator account to access each departmental category as the manager account between the corresponding PC device and the remote server.

17. The method for providing anonymous peer feedback for work teams as claimed in claim 14 further comprises the steps of:
providing an administrator account managed by the remote server, wherein the administrator account is further associated a corresponding PC device; and
enabling the administrator account to adjust global settings to the manager account and the employee accounts for each departmental category between the corresponding PC device and the remote server.

18. The method for providing anonymous peer feedback for work teams as claimed in claim 1 further comprises the steps of:
providing an occupational role for each employee account stored on the remote server; and
prompting each employee account to select the desired message from a restricted set of messages during step (C), wherein the restricted set of messages is a subset from the plurality of predetermined feedback messages based on the occupational role for each employee account.

19. The method for providing anonymous peer feedback for work teams as claimed in claim 1 further comprises the steps of:
providing a history of forwarded feedback messages for each employee account stored on the remote server;
providing a specified threshold of forwarded messages stored on the remote server;
calculating a total number of messages from the history of forwarded feedback messages for each employee account with the remote server; and
preventing executing of step (G) for the specific employee account, if the total number of forwarded messages for the specific employee account is less than the specified threshold of forwarded messages.

20. The method for providing anonymous peer feedback for work teams as claimed in claim 19 further comprises the steps of:
wherein each received feedback message is associated with an origination employee account from the plurality of employee accounts; and
chronologically storing the desired message within the history of forwarded feedback messages for the origination employee account.
